(19) United States
(12) Patent Application Publication
(10) Pub. No.: US 2014/0073150 A1
(43) Pub. Date: Mar. 13, 2014

(54) BATTERY CONNECTOR DECREASING SOLDERING MATERIAL'S FLOWING TO CONTACTING PART

(71) Applicant: HON HAI PRECISION INDUSTRY CO., LTD., New Taipei (TW)

(72) Inventor: GAO-BING LEI, Shenzhen (CN)

(73) Assignee: HON HAI PRECISION INDUSTRY CO., LTD., New Taipei (TW)

(21) Appl. No.: 14/023,838

(22) Filed: Sep. 11, 2013

(30) Foreign Application Priority Data
Sep. 11, 2012 (CN) 201220459847.2

(51) Int. Cl. H01R 12/70

(52) U.S. Cl. CPC H01R 12/7088
USPC 439/78; 439/626

(57) ABSTRACT

A battery connector, used to connect the battery and PCB, includes an insulating housing and a number of contacts received in the housing. Each contact is equipped with a retaining portion, a soldering portion extending downwardly from a lower edge of the retaining portion, and a contacting portion extending forwardly from a front edge of the retaining portion. A first notch is defined between a lower junction part which is formed between a lower edge of the retaining portion and a rear edge of the contacting portion and the first notch positioned beside the soldering portion.

### BACKGROUND OF THE INVENTION

1. Field of the Invention

The present invention generally relates to a battery connector, and more partially to a battery connector effectively connecting between a battery and a printed circuit board.

2. Description of Related Art

With high-speed development of technology and economy, and people's life is promoted and electronic products such as mobile phones become more and more popular. It is also widely used for battery connector which is installed in electronic products for electrical connection between a PCB.

TW. Utility Model Pat. No. M324892 issued to Zhang on Jan. 1, 2008 discloses a battery connector including an insulating housing and a plurality of contacts received in the housing. The insulating housing defines a retaining groove. The contacts include a retaining part retained in the retaining groove, a contacting part which is electrically contacted with the battery and an connecting part between the retaining part and the contacting part. The bottom of the retaining part is connected with a soldering part. In soldering, excessive soldering material may accumulate around the soldering part and even flow to the contacting part so that it will affect the good connection between the contacting part and the battery.

Hence, an improved battery connector is desired to overcome the disadvantages of the prior art.

### BRIEF SUMMARY OF THE INVENTION

An object of the invention is to provide a battery connector with decreasing soldering material's flowing to the contacting part and thereby increasing connecting stability.

To achieve the above object, a battery connector, used to connect the battery and PCB comprising an insulating housing and a plurality of contacts received in the housing, and each contact is equipped with a retaining portion, a soldering portion extending downwardly from a lower edge of the retaining portion, and a contacting portion extending forwardly from a front edge of the retaining portion; wherein a first notch is defined between a lower junction part which is formed between a lower edge of the retaining portion and a rear edge of the contacting portion and positioned beside the soldering portion.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective, assembled view of a battery connector according to the present invention;

FIG. 2 is an exploded view of housing and contacts of FIG. 1;

FIG. 3 is a perspective, assembled view when the battery connector is in use; and

FIG. 4 is a cross sectional view taken along a line 4-4 in FIG. 3.

### DETAILED DESCRIPTION OF THE INVENTION

Reference will now be made to the drawing figures to describe the present invention in detail.

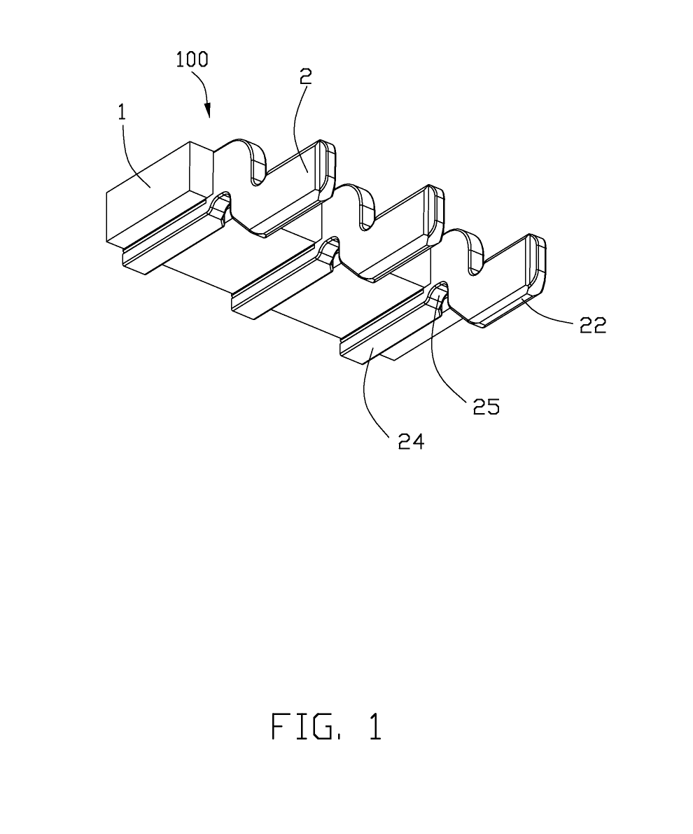

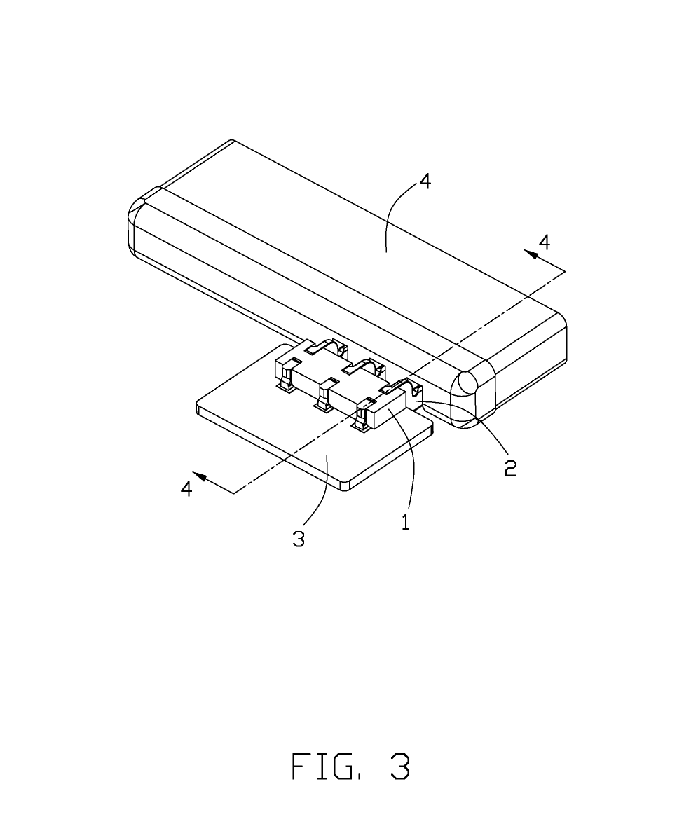

Referring to FIGS. 1-4, a battery connector 100 of the present invention, used for connecting with a battery 4 and a printed circuit board 3 (PCB), includes an insulating housing 1, a plurality of contacts 2 received in the insulating housing 1.

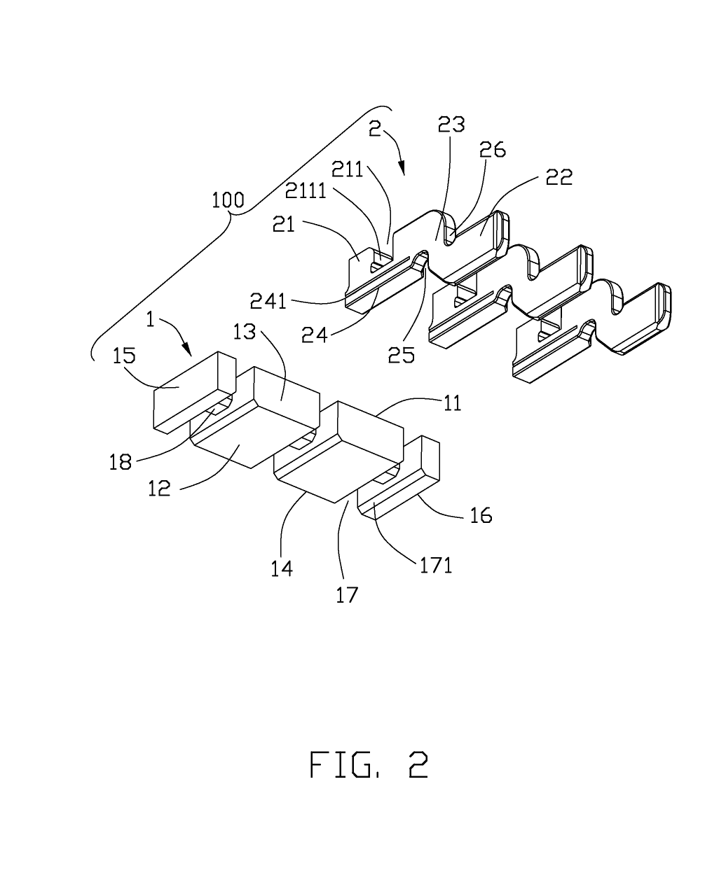

Referring to FIG. 2, the insulating housing 1 is rectangle shaped and has a top face 11, a bottom face 12, a front face 13, a rear face 14, a left face 15 and a right face 16. The insulating housing 1 has a plurality of block portions 101,102,103,104 and a plurality of bridges 18 connecting between each two adjacent block portions 101,102,103,104. therefore, the insulating housing 1 defines a plurality of passageways 17 between each two adjacent block portions 101,102,103,104. The passageways 17 are positioned around the bridges 18. Each block portion has a slant surface 171 at the bottom face 12 for guiding insertion of the corresponding contact 2.

Referring to FIG. 2, each contact 2 comprises a retaining portion 21, a soldering or mounting portion 24 extending downwardly from a lower edge of the retaining portion 21, and a contacting portion 22 extending forwardly from a front edge of the retaining portion 21. The retaining portion 21 has a first protrusion 211 and a second protrusion 212 and therefore, an interspace 210 is defined between the first protrusion 211 and the second protrusion 212. The contacting portion 22 is integral with the second protrusion 212 but the contacting portion 22 is located at a lower height with respect to the retaining portion 21. A first notch 25 is defined between a lower junction part which is formed between a lower edge of the retaining portion 21 and a rear edge of the contacting portion 22. A second notch 26 is defined between an upper junction part which is formed between the front edge of the retaining portion 21 and upper edge of the contacting portion 22. A horizontal groove 241 is formed in a side face of the contact 2 above the mounting portion 24 for reinforcement and anti-wicking consideration.

Referring to FIGS. 1-4, the contacts 2 are assembled to the insulating housing 1 from the bottom face 12 of the insulating housing 1. The contacts 2 are positioned in the corresponding passageways 17. The bridges 18 are positioned in the interspace 210 of the corresponding contacts 2 and therefore, the contacts 2 are retained in the insulating housing 1 because the first protrusions 211 and the second protrusions 212 sandwich the corresponding bridges 18. The soldering portions 24 extend beyond the bottom face 12 of the insulating housing 1 for soldering on a printed circuit board 3. The first notches 25 are positioned beside the soldering portions 24 for receive excessive soldering material accumulated between the soldering portion 24 and PCB 3. The contacting portions 23 are exposed out of the insulating housing 1 for connecting with a battery 4. The battery 4 has a plurality of mating grooves 41 with associated conductors for receiving the contacting portions 23 of the contacts 2. The second notches 26 are positioned frontal of the retaining portions 21 for presenting scrapping occurred between a mating face off the battery 4 and the contacts 2.

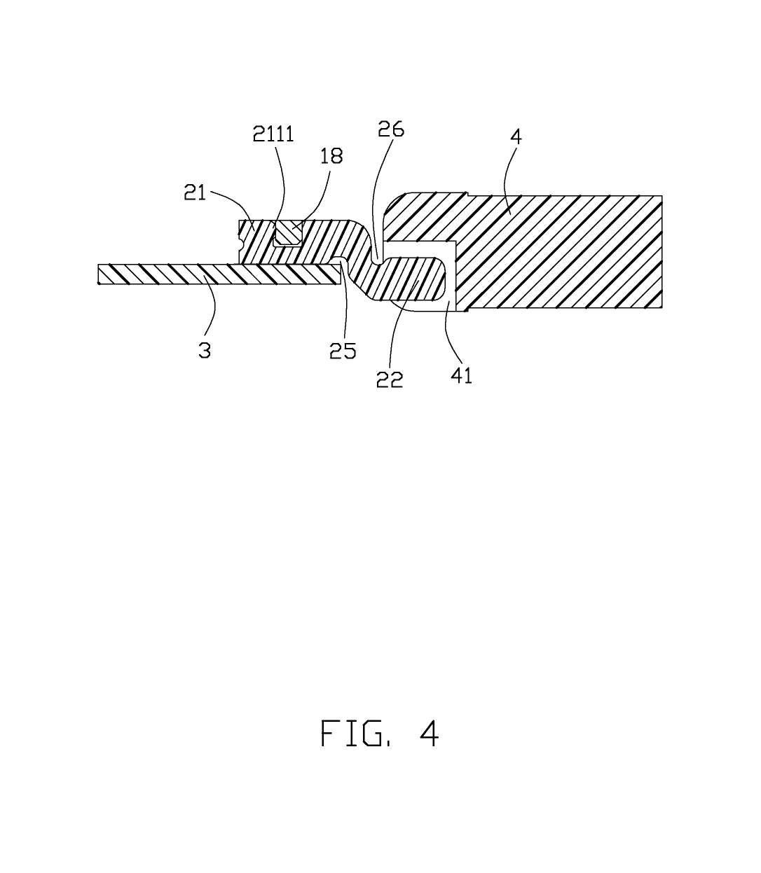

Referring to FIG. 4, the first notch 25 and the second notch 26 of the same contact 2 have oppositely facing openings. Furthermore, the first notch 25 and the second notch 26 of the same contact 2 are offset for a small distance in a mating direction along which the battery 4 is mated with the battery connector 100.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery connector, used to connect a battery and a printed circuit board (PCB), comprising:
an insulating housing; and
a plurality of contacts received in the housing, each contact equipped with a retaining portion, a soldering portion extending downwardly from a lower edge of the retaining portion, and a contacting portion extending forwardly from a front edge of the retaining portion;
wherein a first notch is defined between a lower junction part which is formed between a lower edge of the retaining portion and a rear edge of the contacting portion and the first notch positioned beside the soldering portion.

2. The battery connector as claimed in claim 1, wherein a second notch is defined between an upper junction part which is formed between the front edge of the retaining portion and upper edge of the contacting portion.

3. The battery connector as claimed in claim 2, wherein the first notch and the second notch of the same contact have oppositely facing openings.

4. The battery connector as claimed in claim 2, wherein the first notch and the second notch of the same contact are offset for a small distance in a mating direction along which the battery is mated with the battery connector.

5. The battery connector as claimed in claim 1, wherein said insulating housing also has a plurality of block portions and bridges connecting between each two adjacent block portions.

6. The battery connector as claimed in claim 5, wherein several passageways are defined between each two adjacent block portions and the passageways are positioned around the bridges.

7. The battery connector as claimed in claim 6, wherein said retaining portion has a first protrusion and a second protrusion and therefore, an interspace is defined between the first protrusion and the second protrusion, and the bridge is received in the interspace.

8. The battery connector as claimed in claim 7, wherein the first protrusions and the second protrusions sandwich the corresponding bridges.

9. The battery connector as claimed in claim 6, wherein said contacting portion is integral with the second protrusion but the contacting portion is located at a lower height with respect to the retaining portion.

10. A battery connector assembly comprising:
a printed circuit board;
an insulative housing seated upon the printed circuit board and extending along a longitudinal direction;
a plurality of passageways side by side formed in the housing along said longitudinal direction, each of said passageways extending in a transverse plane perpendicular to said longitudinal direction;
a plurality of contacts disposed in the corresponding passageways, respectively, each of said contacts including a retention section assembled to the housing, and a mounting section seated upon the printed circuit board, and a contacting section extending around the mounting section along a level below said mounting section and beside an edge of said printed circuit board; wherein
the contacting section is located at a level similar to that of the printed circuit board.

11. The battery connector assembly as claimed in claim 10, wherein the housing defines a plurality of bridges alternately arranged with the passageways along said longitudinal direction, and the mounting section of the contact defines a notch receivably engaged with the corresponding bridge.

12. The battery connector assembly as claimed in claim 10, wherein said contact defines a U-shaped configuration including said retention section, to sandwich the corresponding bridge.

13. The battery connector assembly as claimed in claim 12, wherein the U-shaped configuration is upwardly exposed to an exterior.

14. The battery connector assembly as claimed in claim 10, wherein a horizontal groove is formed in a side face of the contact above the mounting section and close to a bottom face of the housing.

15. The battery connector assembly as claimed in claim 10, further including a battery having mating grooves at the same level with the contacting sections to receive said contacting sections therein.

16. The battery connector assembly as claimed in claim 10, wherein said housing and the contacts are configured to allow the contacts to be inserted into the corresponding passageways, respectively, in an upward vertical direction perpendicular to said longitudinal direction.

17. The battery connector assembly as claimed in claim 10, wherein a notch is formed around a junction area between the mounting section and the contacting section, around the mounting section, to intimately confront said edge of the printed circuit board.

18. A battery connector assembly comprising:
a printed circuit board;
an insulative housing seated upon the printed circuit board and extending along a longitudinal direction;
a plurality of passageways side by side formed in the housing along said longitudinal direction, each of said passageways extending in a transverse plane perpendicular to said longitudinal direction;
a plurality of contacts disposed in the corresponding passageways, respectively, each of said contacts including a retention section assembled to the housing, and a mounting section seated upon the printed circuit board, and a contacting section extending around the mounting section along a level below said mounting section and beside an edge of said printed circuit board; wherein
a notch is formed around a junction area between the mounting section and the contacting section, around the mounting section, to intimately confront said edge of the printed circuit board.

19. The battery connector assembly as claimed in claim 18, wherein said contact defines a first height above the printed circuit board, while the contacting section defines a second height beside said edge of the printed circuit board, said first height being similar to said second height.
